(19) United States
(12) Patent Application Publication
(10) Pub. No.: US 2026/0309665 A1
(43) Pub. Date: Oct. 8, 2026

(54) DEVICE AND METHOD OF MEASURING THE WATER CONTENT IN THE REFRIGERANT OF A REFRIGERATION CYCLE

(71) Applicant: DANFOSS A/S, Nordborg (DK)

(72) Inventors: Kumaran CHANDRAN, Chennai (IN); Vahid KHORSHIDI, Sonderborg (DK); Ali FOULLADPOUR, Flensburg (DE)

(21) Appl. No.: 19/481,293

(22) PCT Filed: May 14, 2024
(86) PCT No.: PCT/EP2024/063134

§ 371 Date: Nov. 4, 2025

(30) Foreign Application Priority Data
May 18, 2023 (IN) 202311034833
Jul. 11, 2023 (DK) PA202370376

(51) Int. Cl. G01N 27/22; F25B 49/00

(52) U.S. Cl. CPC G01N 27/221; F25B 49/00; G01N 27/226; G01N 27/228; F25B 2700/00

(57) ABSTRACT

The invention relates to an apparatus (2) for measuring the water content of a refrigerant (6). The apparatus (2) comprises at least one control logic (3) and at least one capacitive sensing element (4) that comprises at least two electrodes (7), wherein the apparatus (2) is designed and arranged in a way that the refrigerant (6) is present between said two electrodes (7). The control logic (3) measures the capacitance of the capacitive sensing element (4) and derives a measurement signal to be outputted that is indicative of the water content. The capacitive sensor element (4) is designed and arranged as a direct current-decoupled device.

Refrigeration cycles are frequently used in a variety of technical fields. Due to increasing levels of requested comfort, but also due to new fields of usage, the number of refrigeration cycles that is actively used by customers and that is produced was increasing in the past, and is to be expected to increase even further in the foreseeable future. In particular, refrigeration cycles are used for refrigerators, freezers and all types of cold storage areas, both in stationary and mobile applications. Furthermore, refrigeration cycles are becoming more and more widespread for heating purposes, namely as so-called heat pumps. This is not only true for stationary purposes, where heat pumps are already known for several years. Rather, they became more and more widespread for mobile applications, in particular as an efficient heating means for electric vehicles.

Irrespective of the application in question, refrigeration cycles tend to agglomerate water, resulting in a steadily increasing water content in the refrigerant. This water content is problematic, for example in that it alters the refrigerants in an adverse way, in that it may cause corrosion effects, and also in that the water is prone to freeze as solid ice structures at certain parts and areas of the refrigeration cycle, when the cycle is in use. This regularly influences the efficiency and effectivity of the refrigeration cycle in an adverse way. Even more, mechanical parts may become mechanically blocked or become stuck, which may result in an inoperative refrigeration cycle after a certain operational time and/or under certain environmental conditions, and may even lead to a damage of certain parts of the refrigeration cycle, in particular of the compressor. This has to be avoided, of course.

The simplest approach is to perform regular maintenance operations, during which the refrigerant/the refrigeration cycle is cleaned of its water content and also of other problematic substances, either by filtering or by replacing the refrigerant. However, frequent maintenance results in correspondingly high cost and frequent downtime of the machinery, which is of course not desired.

Therefore, to prolong the times between two consecutive maintenance operations, it is a widespread practice to include a filter cartridge that contains a desiccant within the refrigeration cycle. This desiccant absorbs water in a physical and/or chemical way. Therefore, depending on the size of the filter cartridge, the mass and the adsorptive strength of the desiccant, a significant increase of the time intervals between two consecutive maintenance operations can be realised. On the negative side, such desiccants do not only form a cost factor, but they also require a certain volume, which may prove to be problematic, in particular for mobile applications.

Another approach that is frequently used in the state-of-the-art to prolong the time intervals between two consecutive maintenance operations is to only perform a maintenance operation when it is really needed, and not on a precautionary base after a certain time span has passed and/or after a certain operational time.

For realising this approach, some kind of measurement of the water content inside of the refrigeration cycle is needed. When realising the economical importance of maximising the time intervals between maintenance operations, it is not surprising that a variety of possibilities has been proposed in the past to perform such a measurement of the water content in a refrigerant/in a refrigeration cycle.

One possibility is to use a filter cartridge with a desiccant that changes colour when it is saturated with water. This, however, requires the provision of a transparent window. Another problem is that the colour change of the desiccant is normally not very profound, so that readouts are problematic and even erroneous readouts may easily occur.

Another suggestion is made in European Patent EP 0 589 968 B1, where it is suggested to use a capacitive sensing element with electrodes that are placed in direct electric contact with the refrigerant. The electrodes consist of two different metals with different normal potentials. The determination of humidity is carried out by measuring a resistive loss in the sensing element. For this, the sensing element is connected to an AC voltage (alternating current voltage) source and to an electrical circuit that comprises means for converting the resistive AC voltage loss in the capacitive sensing element to an absolute DC voltage (direct current voltage), the absolute DC voltage being a measurement value for humidity. Furthermore, an absolute DC current is measured between the electrodes to measure the content of an acid.

While this apparatus works satisfactorily, the different normal potentials of the electrodes and the direct electrical contact between the electrodes and the refrigerant do always introduce a mechanism for generation of corrosion, not necessarily only of the electrodes, but also of other parts of the refrigeration cycle. Furthermore, the therein suggested apparatus may prove to be problematic in combination with certain refrigerants and/or in certain environments.

Yet another proposal was made in WO 2018/025533 A1. Here, a capacitive sensing element with electrodes is used, where a desiccant is arranged between the electrodes of the capacitive sensing element. Therefore, a change in the dielectric constant of the desiccant due to an increasing saturation with water over time is measured by the capacitive sensing element. Once a certain threshold of the saturation of the desiccant is exceeded, the user is informed.

It is therefore an object of the invention to propose an apparatus for measuring the water content of a fluid, in particular of a refrigerant, that is improved over apparatuses for measuring the water content of a fluid, in particular of a refrigerant, as they are known in the state-of-the-art.

It is another object of the invention to propose a refrigeration cycle that is improved over refrigeration cycles that are known in the state of the art.

Yet another object of the invention is to propose a method for measuring the water content of a fluid, in particular of a refrigerant, that is improved over methods of measuring the water content of a fluid, in particular of a refrigerant, as they are known in the state-of-the-art.

An apparatus for measuring the water content of a fluid, in particular of a refrigerant, according to the present suggestion solves this object. Also, a refrigeration cycle and a method for measuring the water content of a fluid, in particular of a refrigerant, according to the present suggestion solves this object.

It is suggested to design an apparatus for measuring the water content of a fluid, in particular of a refrigerant, wherein the apparatus comprises at least one control logic and at least one capacitive sensing element comprising at least two electrodes, and wherein the apparatus is designed and arranged in a way that the fluid is present between said two electrodes, wherein further the control logic measures the capacitance of the capacitive sensing element and derives a measurement signal to be outputted that is indicative of the water content in a way that the capacitive sensor element is designed and arranged as a direct current-decoupled device. In particular, the control logic may be designed and configured to do so.

The fluid to be measured can be, in principle, any type of fluid, including a liquid, a gas, a mixture of a gas and a liquid, as well as a supercritical fluid, where no clear distinction between a liquidous and a gaseous phase can be made anymore.

Furthermore, it is possible that the fluid may contain a different substance to a certain percentage, in particular fluid droplets of a different substance and/or of solid particles. In particular, the fluid may be a refrigerant, in particular a somewhat commonly used refrigerant. For example, R134a, R744 (CO₂), R404, propane, and the like may be envisaged. In the light of the aforesaid, this refrigerant may contain a certain amount of lubricating oil (lubricating oil droplets) or the like. This particularly applies if the apparatus is arranged in a complete system that is in operation, for example within a refrigeration cycle that is operating (refrigerant is circulated by a compressor). It is to be noted that particularly in case of a refrigerant in a refrigeration cycle, the physical phase of the refrigerant may be different (and actually will usually be different) in different parts of the system (refrigeration circuit), when the system is in operation. Even within the presently suggested apparatus/within the capacitive sensing element/around the electrodes of the capacitive sensing element, the physical phase (in particular gaseous and/or liquidous phase) of the fluid may vary significantly depending on an operational mode the full system is operated in (for example load on the system, actuation of the compressor, setting of the pressure drop inducing device (throttle valve), actuation of the condenser's fan, actuation of the evaporator's fan) and/or may vary widely over time and/or may depend on environmental conditions (for example ambient temperatures) and/or on where the capacitive sensing element is arranged within the full system (fluid circuit/refrigeration circuit).

The electrodes may be made of essentially any material and/or may comprise essentially any shape. Usually, however, the at least two electrodes comprise at least in part an electrically conductive substance, in particular a substance that is electrically conductive for AC currents. Usually metals (in particular copper) or metal alloys (in particular copper alloys) are used for this. It is to be noted that the electrodes may comprise, at least to a certain extent and/or at least in certain areas, an electrically isolating material, in particular with respect to DC currents. Just to name an example, the electrodes may be made of an electrically conductive material, while an electrically insulating coating is applied on the surface of the electrically conductive material. The at least two electrodes may comprise at least in part a different material and/or may show at least in part a different design, but may preferably be made of essentially the same materials and/or may show the same or at least a similar design. With respect to the shape/design of the electrodes, the electrodes may show a rod-shaped design, a spirally wound design, a design with a linear conductor that is arranged in a zig-zag-like arrangement or a planar-like design, in particular a plate-like design or a (partial) barrel-like design. Is to be noted that is of course possible to employ more than two electrodes, like three electrodes, four electrodes, five electrodes, six electrodes, seven electrodes, eight electrodes, nine electrodes, ten electrodes, or even more electrodes. It is to be noted that usually there is a slight preference on an even number of electrodes. In particular, in an effort to enhance the sensitivity of the arrangement, the apparatus is designed and arranged in a way that the fluid is present between said two electrodes, if the apparatus is used in the system it is intended to be used in/in a way, the apparatus is designed for. This may be realised in a way that there is a certain spacing between the fluid and at least one of the two electrodes (for example by using a separating wall, a distinct gap of air between the fluid and the respective electrode, or the like). Preferably, however, it is suggested that at least one of the at least two electrodes is in (direct) contact with the fluid to be measured. It is to be noted that this contact does not exclude the possibility of the presence of an insulating layer between the electrically conductive parts of the respective electrode and the fluid to be measured or the like. The contact may relate to a comparatively small surface area, but also to a comparatively large surface area. As an example, one of the large sized surfaces (main surfaces) of a plate-like shaped electrode may be in contact with the fluid to be measured.

The space between the at least two electrodes (preferably between the majority of the electrodes, more preferably between (essentially) all of the electrodes) is preferably designed as a non-water absorbing space. This can be realised in a way that (essentially) no material is placed between the electrodes (in case of electrodes that are covered with a surface coating, for example by an electrically insulating material, this may relate to the space between the surface coatings). Put in other words, the space between the at least two electrodes is designed and arranged to be a non-water absorbing (solid-state) material free recess/space between electrodes. Of course, when the apparatus is in its operational state, this space between the electrodes (recess) will be filled with the refrigerant (gaseous and/or liquidous), and possibly some impurities (like an increasing amount of water during operation of the full machinery between two maintenance intervals; however, other impurities may be present, like lubricating oil, or possibly even some solid-state material particles due to wear of certain components, or the like). However, it is also possible to arrange a solid-state material between the at least two (or more) electrodes. The solid-state material may be a solid material, or may be a porous material. Further, the solid-state material may be provided in form of a plurality of separate pieces (where the pieces may be made of the same material, or of different materials). This solid-state material will typically fill the majority, preferably (essentially) the whole space between the at least two (or more) electrodes. As an example, it may fill at least 10%, 20%, 30%, 40%, 50%, 60%, 70%, 80%, 90%, 95%, 96%, 97%, 98% or 99% of the volume of the recess between the at least two (or more) electrodes. In particular, refrigerant fluid flow channels may be provided between the solid-state material and the electrodes and/or between separate pieces of the solid-state material. However, the solid-state material should show largely/(essentially) completely non-water absorbing properties. This may be interpreted in a way that in the material does not absorb any water.

However, it is also possible that the material has a characteristic that water may be absorbed in the porous material under certain operational conditions, but may be released under different operational conditions again. Those “operational conditions” are typically meant to be conditions that may reasonably occur during normal operation of the machinery, the apparatus will be used for, in particular during normal operational characteristics of a refrigeration cycle/heat pump cycle. As an example, for such a solid-state material, plastic material may be used. It is to be noted that such a solid-state material is typically used for commercially available humidity sensors (as they were commercially available at the priority/filing date of the present application). Just to name two examples: a relative humidity sensor, type HS1101LF, production design as marketed by technical leaflets in 2015 by TE sensor solutions (TE connectivity company, Toulouse, France); or Honeywell Humidlcon digital humidity sensors, HIH8000 series, production design as marketed by technical leaflets in 2015 by Honeywell company, MN, USA, may be used for this purpose. Therefore, typically no water desiccant material or the like should be used as a part of the apparatus/sensor element. It is to be noted that such a design may prove to be particularly advantageous, because the apparatus/sensor element can be continued to be used, even if any desiccant in the refrigeration cycle becomes saturated and/or has to be replaced. As a side remark, it should be noted that the solid-state material (if present) may act as a dielectric substance, thus influencing the capacitance of the presently proposed apparatus, possibly increasing the sensitivity of the apparatus. Indeed, first experiments do indicate that a capacitive sensing element comprising a solid-state material between the electrodes (in particular if said solid-state material comprises or (essentially) consists of a polymeric material/a polymer) is more sensitive as compared to a capacitive sensing element with a (solid-state) material free space between the electrodes. Nevertheless, it is to be noted that a measurement of the water content in the fluid (or of different parameters of the fluid, like its ratio value of gas versus liquid) is irrespective of the dielectric constant (and even more of a change of the dielectric constant over time) of the solid-state material between the at least two electrodes. Put in other words, the measurement is based on a direct measurement of the capacitive influence by the fluid/on a direct measurement of the dielectric properties of the fluid between the electrodes.

The control logic may be an electronic control logic. In particular it may comprise analog parts, where a calibration may be made using standard calibration techniques, like the use and appropriate setting of variable resistors, variable capacitors or the like. Preferably, however, the control logic may comprise a digital processing device like a programmable digital computing unit, in particular an electronic controller, a printed circuit board computer device or the like. The measurement signal that is outputted may be outputted in analog form (for example a variable voltage, where the level of the output voltage is indicative of the measured capacitance of the capacitive sensing element) or may be outputted in a digital form. The output signal, in particular a digital output signal, may be sent on a dedicated line, but also may be sent via a bus system.

When talking about an AC current in the current context, this notion has usually to be understood in a broad way. In particular, it is not limited to “standard sinusoidal AC currents” and/or to currents showing an alternating positive and negative voltage at the electrodes. Rather, currents showing a DC offset and in particular currents that do not change between positive and negative voltage at all (but only vary by the voltage level over time, in particular in a repeditive/periodic way) are to be encompassed by the notion of an “AC current” in the current context. Such types of AC voltage may even be preferred. Also, the shape of the AC current may be different from a sinusoidal shape and may be, in particular, of a rectangular shape, a sawtooth-like shape, a triangular shape and so on. Even further, the aspect ratio may vary. As an example:when using a rectangular shape for the AC current, the length of the times when the voltage is at the high point may be different from the length of the times when the voltage is at the low point.

As a preferred AC current for measuring the capacities, in particular a rectangular signal may be used, where a change between 0 V (no voltage applied) and a positive (or a negative) voltage level (where the exact voltage level may be chosen according to actual needs) occurs in a repetitive way. During the positive signal phase, the capacitive sensing element (the capacitor-like arrangement thereof) is charged. When the applied voltage is switched to 0 V, the charge Q (as measured in Coulomb=C) that is stored in the capacitive sensing element may be measured. For this, one may measure the (discharging) current I and the time t that is necessary until the capacitive sensing element is (essentially) fully discharged. Then, the charge Q can be calculated using Q=I·t (or rather Q=∫I(t)dt, when assuming a non-constant current). Then, the capacitance can be determined using

$$C = \frac{Q}{U} ( or rather C = \frac{\int I ( t ) dt}{U} ,$$

when assuming a non-constant current; and even

$$C = \int \frac{I ( t )}{U ( t )} d t ,$$

when assuming a non-constant current and a non-constant voltage).

When using the notion of “indicative of the water content” in the present context, this may be interpreted in a way that the outputted measurement value does not necessarily has to be in units of water mass, water volume, PPM (parts per million), or the like. In other words, it is not required that there is a more or less profound linearity between the outputted measurement value and the water content in the fluid. This task of converting the respective signal may be performed by other devices, being not part of the presently suggested apparatus (if such a task is performed at all). It is to be noted that regularly it is not required to have a more or less precise absolute value of the water content in the fluid. Rather, it is often sufficient to have knowledge on whether the water level is sufficiently low, or whether it is at or above a level that raises concern (i.e. indicating the requirement of a maintenance process to be performed). Possibly an additional output level, like a kind of an “advance notice output”, indicating that the respective system approaches a status in which a maintenance cycle is required, might be realised. Therefore, even a binary signal (in particular if no “advance notice level” is needed) or a signal showing three states (one of those being an “advance notice indication”) might be considered to be an output measurement signal that is indicative of the water content in the sense of the present disclosure.

According to the present suggestion, the capacitive sensor element is designed and arranged as a direct current-decoupled device. This may be interpreted in a way that the measurement is (essentially) solely based on an AC current that is applied (and whose response signal is measured). Reference is made to applying a rectangular voltage signal, having a repetitive series of 0 V voltage and a positive (or a negative) finite voltage, as previously described. In particular, a DC electric current (part) may be present, but will not be used for measurement, or a DC electric current may preferably be blocked, hindered and/or not generated by the presently proposed apparatus. In particular, such a blocking/hindrance may be realised by the design of the apparatus itself, in particular by the design of the electrodes, the remaining parts of the capacitive sensing element and/or by the at least one control logic. This, however, does not exclude the possibility that a DC current is applied to the sensor element externally. Then the sensor element may do the necessary conversion to an AC current internally.

In particular it is suggested that the apparatus is designed and arranged in a way that said at least two electrodes consist of (essentially) the same material and/or are electrically isolated from the fluid to be measured. Using the same materials for the electrodes may result in better measurement values and in a simpler to implement manufacture of the apparatus, in particular of the capacitive sensing element.

Furthermore, by using the same material, galvanic corrosion can usually be reduced or even (essentially) avoided. Therefore, the usable lifetime of the presently proposed apparatus can be advantageously increased. Yet further, by using the same material, the generation of a DC-current by the electrodes themselves (in particular due to a different normal potential of the electrodes) can be reduced, or usually (essentially) be avoided. Additionally or alternatively, an electric isolation may be used. This may be realised by applying a coating onto the electrically conductive part of the electrodes, where the coating comprises or consists of an electrically nonconductive (electrically isolating) material. As an example, some kind of a resin, a plastic material or a lacquer may be applied to the respective surface(s). Different techniques may be used as well, for example chemical vapour deposition, physical vapour deposition or other deposition techniques. Even further, some kind of a housing or an intermediate wall, separating the respective part of the electrode from the fluid in the capacitive sensing element may be envisaged as well.

Nevertheless, for completeness it should be stated that is also possible that electrically conductive parts of the electrodes are in direct electric contact (i.e. in an electrically conductive way; in particular with respect to DC current) with the fluid to be measured. Furthermore, it is possible that the electrodes do comprise or do consist of different materials. In particular this may not only relate to the use of completely different materials like different metals, but also to the use of different alloys, where the percentages of the metals used are varying and/or where (some of) the metals that are contained in the alloy do vary, for example. In case that more than two electrodes are used, it is possible that all (or a certain fraction of the) electrodes consist of the same material and/or are electrically isolated from the fluid to be measured and/or are designed in the same or in a different way. Put differently, in case that more than two electrodes are used, it is possible that all (or a certain fraction of the) electrodes consist of a different material and/or are in direct electrical contact with the fluid to be measured and/or are designed and arranged in a (partially) different way. As a matter of completeness, this is irrespective of whether the space between the at least two electrodes is empty or (partially) filled with a non-water absorbing solid-state material, or the like.

It is suggested to design and arrange the apparatus in a way that said at least two electrodes are designed and arranged to be in (direct or indirect) contact with the fluid, preferably in a way to be essentially immersed in the fluid to be measured. The notion of an “indirect contact” may relate to a metallic electrode that comprises an isolating coating. This way usually a good measurement preciseness can be achieved. Only for completeness, it should be mentioned that this immersive arrangement can be realised for the case that the space between the at least two electrodes does not comprise any (solid-state) material, but also for the case that the space between the at least two electrodes is (partially) filled with a non-water absorbing solid-state material.

Further, it is proposed to design and arrange the apparatus in a way that the water content of a fluid with a dielectric constant of less than 70, preferably of less than 60, even more preferred of less than 50 is measured. However, a different (relative) dielectric constant is possible as well, like less than 75, less than 40, less than 30, less than 25 or less than 20. Is to be noted that the (relative) dielectric constant of water is about 80. Therefore, when using a fluid with a dielectric constant as aforementioned, a sufficient distance to the dielectric constant of water is present, therefore rendering a sufficiently high quality/preciseness of the capacitance measurement. The dielectric constant is commonly denoted in formulae with the Greek letter Epsilon (ε). Just to name some examples, ethylene glycol has a dielectric constant of 37, R134a of 9.2, R404 of 14, propane of 1.6, and R744 of 1.45.

Further, it is suggested to design the apparatus in a way that the control logic generates a water content signal, in particular a PPM value (PPM=parts per million), preferably using prior calibration data. When employing this embodiment, the generated output may be particularly universally usable. In particular, the value can be easily read out and used by a machine shop to determine a future maintenance plan or the like. Furthermore, using such output data, the output data can be used irrespective of the manufacturer of and/or the exact design of the presently proposed apparatus. This may enhance the universal applicability of the presently proposed apparatus. The prior calibration data may come from the apparatus, as actually used. Usually, however, the prior calibration data may refer to a genuine sample (out of a series of production units or a sample item before production is started) that was built and tested at the manufacturer's site or the like. Then, the respective prior calibration data may be stored in the memory of the control logic of the apparatus (or introduced in a different way, like by applying a certain setting of variable resistors, variable capacitors or the like). It is to be noted that in particular the present proposal may be realised particularly well in case a programmable digital device forms part of the at least one control logic. In particular, a PROM, an EPROM, an EEPROM, a nonvolatile RAM or the like can be used for this. Only for completeness, it should be mentioned that it may be possible to reprogram/reset the apparatus in case that modified and/or improved calibration data becomes available. Only for completeness, it should be mentioned that the calibration data (the setting of the control logic in general) will usually depend on the type of refrigerant in use, in particular if the control logic is used to generate a water content signal. Furthermore, the respective data may be stored in form of a water content lookup table/PPM lookup table, or by using a formula with (typically) a plurality of parameters, where the parameter(s) may be set according to prior calibration data.

In this context, it should be mentioned that first experiments indicate that at least for certain embodiments of the presently disclosed apparatus, the measured capacitance ranges are distinct for certain operational conditions and/or certain conditions of the refrigerant. Namely, it was observed in first experiments that at least for some setups, the gaseous state of the refrigerant yields the lowest capacitances of the apparatus (first interval of measured capacitance; lowest capacitance interval). Then, a second capacitance interval (medium capacitance interval) with a higher capacitance follows, in which a mixture of gaseous and liquidous refrigerant is present between the at least two electrodes of the apparatus. Then, a third interval of measured capacitance follows (highest capacitance interval), in which the refrigerant is in a (essentially) fully liquidous state, where the capacitance increases with increasing water content of the (fully liquid) refrigerant. There is also some indication that the water content may have an only minuscule effect on the measured capacitance in the first and the second interval. At least in such cases, the control logic should be designed and arranged in a way that this behaviour is considered during the design process and/or in a way that water content measurements are only performed/considered during operational conditions of the machinery the apparatus is used in, in which an (essentially) liquid (only) refrigerant is present in the apparatus/sensor. Furthermore, the apparatus should be appropriately placed in a machinery. Both conditions, however, usually do not pose any significant problem for employing an apparatus according to the present disclosure. It is to be noted that the water content in the refrigerant of the refrigeration cycle usually varies only very slowly, typically on a timeframe of at least weeks, typically months or years. Therefore, even if a set-up is chosen, in which the refrigeration cycle (or another type of machinery, the apparatus is used in) reaches an operational state, in which the refrigerant becomes (essentially) liquid at the position of the apparatus/sensor element chosen only from time to time (as an example only every couple of days), this is still more than fast enough for determining the water content of the refrigerant in a (closed) refrigeration cycle, and to issue an appropriate signal to the user of the apparatus.

Even further, it is suggested to design the apparatus in a way that the control logic outputs a warning signal in case a certain water content level is exceeded and/or in a way that the control logic outputs an estimated remaining time until a certain water content level is prone to be reached or exceeded. This way, a maintenance can be performed and possibly even scheduled (probably well) ahead of actual need, depending on the actual use of the apparatus and/or the system, the apparatus is used in. This way, maintenance intervals can be set according to actual needs, and need not to be based on a fixed schedule. Therefore, usually maintenance intervals can be prolonged. On the other hand, in case an increased water content is detected that is exceeding the usual increase of water content over time (which in turn could cause a reduced effectivity or even a damage of the apparatus/the system, the apparatus is used in), a required “early” maintenance can be performed as well.

Further, it is suggested to design the apparatus according to the present disclosure in a way that the control logic also calculates a ratio value of gas versus liquid in a gas-liquid mixture fluid and/or a value of bubble content in the liquidous phase of the fluid and/or a value of droplet content in the gaseous phase of the fluid, based on the measured capacitance of the capacitive sensor element. Surprisingly, by performing a capacitance measurement, in particular by performing a direct current-decoupled capacitance measurement, it is also possible to measure, or at least estimate in a sufficiently precise way, a ratio of gas versus liquid in a gas-liquid-mixture fluid (refrigerant), a value of a bubble content in the (mainly liquidous) fluid (refrigerant) and/or a value of droplet content in the (mainly gaseous) fluid (refrigerant). A faulty assignment of the measured capacitance to one of the various values that are to be measured (i.e. the water content, the gas versus liquid ratio and so on) can be particularly avoided by using the timescale of the respective measured capacitance value, by using the time evolvement of the measured capacitance value and/or by using the ambient conditions in which the measurement is made. As an example, the timescale of the change and the behaviour of the change of the measured capacitance value differs between the respective effects to be measured. In particular, a water content of the fluid will usually change on a timescale of weeks, months or even years. Furthermore, the water content will usually not change initially, at least not considerably, since the initial influx of water into the refrigeration cycle will be absorbed by the desiccant in the filter cartridge (if present). Only after a time span of typically months to years, the water content will start to increase with a somewhat higher rate/slope. On the other hand, a ratio of gas to liquid, a bubble content and/or a droplet content will usually change on a timescale of several minutes, several seconds or even less. These different behaviours with respect to timescales and time evolvement of the measurement values can be considered and evaluated by the control logic, in particular if the control logic comprises a programmable digital device. It is to be noted that first experiments indicate that the fast variation of the capacitance of the apparatus that is based on changes of the ratio value of gas versus fluid in a gas-liquid mixture fluid and/or changes of the value of bubble content in the liquidous phase of the fluid and/or a value of droplet content in the gaseous phase of the fluid applies both to the case, in which the space between the at least two electrodes is empty, but also to the case in which the space between the at least two electrodes is (partially) filled with a non-water absorbing material/solid-state material/porous material. In particular this might feel a little bit surprising. Nevertheless, in first experiments it was determined that at least for many solid-state materials, and even for many porous materials, the indicated timescales are more than realistic. Even more, for a significant number of materials it seems that the speed of the fluctuations is rather limited by the sampling rate/sampling speed of typical commercially available analog-digital converters, and not by a “slow-down effect” due to the solid-state or even porous material.

According to a further suggestion, a refrigeration cycle is suggested that comprises a compressor, a condenser, a pressure drop inducing device and an evaporator, and that further comprises an apparatus according to the present disclosure. The pressure drop inducing device may be particularly a (controllable) throttle valve, a plug, a fluid throughput reducing device, a (controllable) orifice, a (controllable) expansion device, a (controllable) pressure reducing device, or the like. This will result in a particularly sensible use of the presently proposed apparatus. Put in other words, the resulting refrigeration cycle can be particularly versatile and may show the mentioned features and characteristics, at least in analogy. Depending on the requirements, it is certainly possible that the actuation cycle comprises one or a plurality of economisers (i.e. usually a sub-cooler type heat exchanger that uses part of the total refrigerant flow from the condenser to cool the rest of the refrigerant flow: the refrigerant flow is divided between the condenser and the pressure drop inducing device; a smaller flow is passed through an additional pressure drop inducing device and evaporated in the economiser at an intermediate pressure to cool the main flow that is fed into the evaporator). Preferably, the refrigeration cycle comprises a filter cartridge and/or a desiccant, more preferably a filter cartridge containing a desiccant. For the filter cartridge/desiccant, a well-known design may be used, where the filter cartridge/desiccant is placed in a tubular receiving space, where the tubular receiving space is formed integrally with the condenser. However, the filter cartridge/desiccant may be arranged separately from the condenser, as well. Furthermore, the filter cartridge/desiccant may not only be arranged between the condenser and the pressure drop inducing device, but also at a different place. An example for this would be to arrange the filter cartridge/desiccant in the suction line of the compressor (i.e. between the evaporator and the compressor). Only for completeness: it is also possible to use a plurality of filter cartridges/desiccants, in particular at different locations within the refrigeration cycle.

In particular, the refrigeration cycle may be modified in the sense of the present disclosure, at least in analogy. This may result in similar characteristics and advantages of the resulting refrigeration cycle.

In particular it is possible to design the refrigeration cycle in a way that said at least one capacitive sensing element is arranged between the condenser and the pressure drop inducing device and/or between the evaporator and the compressor and/or between the compressor and the condenser. When the capacitive sensing element is placed in (one of) these positions, the refrigeration cycle may show the best results, in particular with respect to the measurement value obtained by the respective apparatus. It is to be mentioned that it is of course possible to use a plurality of apparatuses, in particular at different locations (in particular at the mentioned locations) within the refrigeration cycle. While first experiments have shown that it is usually not preferred to place said at least one capacitive sensing element between the pressure drop inducing device and the evaporator, there might be cases where this arrangement may be advantageous, in particular in case an additional capacitive sensing element is used (i.e two or more capacitive sensing elements are used).

It is to be noted that placing the (or an additional) apparatus between the condenser and the pressure drop inducing device will usually be particularly advantageous, if a ratio of gas versus liquid of the fluid is to be measured, in particular if a gas bubble content is to be measured. This way, the refrigeration cycle may be controlled in a way to be particularly efficient, in particular in a way to optimise the efficiency of the condenser. Also, it is possible to avoid an adverse controllability of the refrigeration cycle, because the pressure drop inducing device usually expects essentially pure liquid for functioning properly. However, first experiments have shown that this location is also particularly advantageous for measuring the water content of the fluid.

If the refrigeration cycle comprises a filter cartridge/desiccant, it is usually preferred if the filter cartridge/desiccant is arranged between the condenser and the pressure drop inducing device. Then, the at least one capacitive sensing element may be arranged between the condenser and the filter cartridge/desiccant and/or between the filter cartridge/desiccant and the pressure drop inducing device. Placing the at least one capacitive sensing element between the filter cartridge/desiccant and the pressure drop inducing device particularly allows to use an integrated arrangement of the condenser and the mounting space for the filter cartridge/desiccant, as it is known as such in the prior art. Placing the at least one capacitive sensing element between the condenser and the filter cartridge/desiccant may improve the quality of the measurement signal. It is to be noted that a filter cartridge/desiccant may become partially blocked over time, which introduces a throttling effect, thus creating a pressure drop and therefore a partial expansion occurs in the filter cartridge/desiccant (for the refrigerant). This may lead to the situation that a certain amount of gas may arrive at the pressure drop inducing device, although the capacitive sensing element senses a purely liquidous phase of the fluid. If, however, the at least one capacitive sensing element is arranged between the filter cartridge/desiccant and the pressure drop inducing device, the measurement signal by the capacitive sensing element may be used to determine whether a (partial) blockage of the filter cartridge/desiccant has occurred. Such an information may be quite valuable.

When the (or an additional) apparatus is placed between the evaporator and the compressor, a gas to liquid ratio within the liquid may be particularly advantageously measured, more particularly the content of liquid droplets in a gaseous phase of the fluid can be advantageously measured. In other words, at this position, a sufficient evaporation of the refrigerant by the evaporator can be measured, which may result in an increased performance of the refrigeration cycle, and in particular a damage of the compressor due to remaining droplets in the refrigerant/fluid may be avoided. A measurement of the gas to liquid ratio downstream of the compressor, in particular the droplet content downstream of the compressor, may be advantageous in connection with certain designs of compressors with liquid injection and/or systems with an economiser. This is because certain designs of compressors may use an influx of liquid droplets for cooling purposes (in particular for cooling the compressor and/or for reducing the compressor discharge temperature) and/or for enhancing the compressor efficiency. Turbo-compressors are an example for such compressors. It is to be noted that an optimum performance of a refrigeration cycle may be achieved (depending on the refrigeration cycle and the working and ambient conditions) if the refrigeration cycle is operated in a way that at certain points within the closed circuit a certain amount of bubbles/droplets is present.

Furthermore, it is suggested that the control logic is designed and arranged in a way that the generation of the measurement signal concerning the ratio value of gas versus liquid and a gas-liquid mixture (in particular a bubble content in the liquidous phase of the refrigerant and/or a droplet content in the gaseous phase of the refrigerant) is (at least at times) based on the fluctuations of the measured capacitance of the capacitive sensing element, preferably on the size and/or the speed of the fluctuations of the measured capacitance of the capacitive sensing element. “Based” in the present context may mean that the fluctuations of the measured capacitance is just one out of a plurality of (at least two) parameters that are considered when generating the measurement signal concerning the ratio value of gas versus liquid in a gas-liquid mixture. However, it might be advantageous if the fluctuations of the measured capacitance are, at least at times/at least for certain working conditions, a major input parameter or even the (essentially) only parameter that is used for generating the measurement signal concerning the ratio value of gas versus liquid in a gas-liquid mixture.

An optimum performance of a refrigeration cycle may be achieved (depending on the refrigeration cycle and the working and ambient conditions) if the refrigeration cycle is operated in a way that at certain points within the closed circuit a certain amount of bubbles/droplets is present, which typically manifests itself in a fastly fluctuating measurement signal. Therefore, detecting such fluctuations may be equivalent to an (approximately) optimum performance of the refrigeration cycle. At least, such a fluctuating measurement signal can be used for detecting a certain working condition for certain control strategies, like the so-called minimum stable superheat control strategy (MSS control strategy), detection of the level of superheat, or the like. The size and/or the speed of the fluctuations may particularly considered to be (or at least to be a value that is based on) the variance of the fluctuations

$$( {\sum }_{i = 1}^{n} \frac{{( {x}_{i} - \overline{x} )}^{2}}{n} ) ,$$

the size and/or speed of the fluctuations, the amplitude of the fluctuations (|x(t)max−x(t)ₘᵢₙ| for neighbouring local extreme points or of those lying within a certain time interval) and/or the (first) time derivative of the fluctuations

$$( \frac{{x}_{i + 1} - {x}_{i}}{Δ t} ) .$$

In particular, the control logic can be designed and arranged in a way to use the fluctuations of the measured capacitance of the capacitive sensing element, preferably the size and/or the speed of the fluctuations of the measured capacitance of the capacitive sensing element to determine the level of vaporisation and/or the level of superheat of the fluid, in particular at the exit of an evaporator. Preferably the control logic is designed and arranged to generate output signals for various parts of the refrigeration cycle in a way that the level of vaporisation and/or the level of superheat of the fluid at the exit of the evaporator is controlled to be at the predetermined level. As already mentioned, the size and/or speed of the fluctuations may be particularly considered to be (or at least to be a value that is based on) the variance of the fluctuations

$$( {\sum }_{i = 1}^{n} \frac{{( {x}_{i} - \overline{x} )}^{2}}{n} ;$$

which is equivalent to the standard definition of variance), the size of the amplitude of the fluctuations (|x(t)ₘₐₓ−x(t)ₘᵢₙ| for neighbouring local extreme points, or of those lying within a certain time interval) and/or the time derivative of the fluctuations

$$( \frac{{x}_{i + 1} - {x}_{i}}{Δ t} ) .$$

To gain a more robust numerical value, it is possible to use an average of the respective value over a certain number of fluctuations, for example an average over up to 5 fluctuations, 10 fluctuations, 20 fluctuations, 25 fluctuations, 30 fluctuations, 40 fluctuations or 50 fluctuations (starting with 1 fluctuation, 2 fluctuations, 5 fluctuations, or 10 fluctuations). According to first experiments, the most preferred value seems to be the variance. Further, first experiments have shown that averaging over 5 to 30, preferably over 10 to 25 fluctuations, even more preferred 15 to 20 fluctuations yields preferred results (using a measurement rate of one measurement per second). Further, as already mentioned, surprisingly even in case the refrigerant is superheated to a certain extent, there are still fluctuations around (for up to some 25 K or 30 K superheat level). Surprisingly, the size and/or the speed of the fluctuations of the measured capacitance is/are a surprisingly good value to determine the level of superheat directly/unambiguously. Indeed, between a vaporisation level of approximately 0%-10% to 0%-20% residual liquid droplets in a generally gaseous phase of the refrigerant at the exit of the evaporator (or in other words: 80%-100% or 90%-100% vapor quality) and up to 20 K to 25 K of superheat, the size and/or the speed of the fluctuations decreases with increasing superheat (initially with decreasing amount of liquidous phase). The most suitable value for this seems to be the variance of the fluctuations. According to first measurements, the variance is increasing with decreasing level of superheat in the relevant observation window.

If the amount of residual liquid in an essentially gaseous phase of the refrigerant and/or the level of superheat is too high relative to a desired value/allowable range of values, standard control strategies can be employed, like reducing the opening degree of the pressure drop inducing device, in particular. While varying the opening degree of the pressure drop inducing device is the standard control method, in particular for simpler designs/less costly designs of refrigeration cycles, different control strategies are known in the prior art as well, and may be additionally or alternatively employed. As an example, it is additionally or alternatively possible to vary the pump capacity of the compressor (in particular if compressors of a variable pumping capacity design are used, like swash plate compressors or the like), to vary the rotation speed of the fans of the evaporator and/or the condenser, or the like. Variation of the speed of the condenser fan and/or of the evaporator fan may encompass a toggling between a switched-on (100%) and a switched-off (0%) position (i.e. some kind of pulse width modulation), a toggling between a switched-on (100%), a partially switched-on (for example 50%; possibly even more intermediary positions) and a switched-off (0%) position, and/or a continuous variability of the speed of the respective fan. It is to be noted that a variation of the pump capacity of the compressor is even possible for fixed displacement compressors (for example scroll compressors, piston compressors and/or axial turbo compressors), for example by varying the driving speed of the respective compressor. In particular, a so-called “minimum stable superheat” (MSS) control strategy can be realised. When the controller detects that the fluid (refrigerant) is in a stable region/dry region, the setpoint of the refrigeration cycle is intentionally modified so that the refrigerant gets closer to the unstable region/wet region. When a critical value (that may be set by the user or at the manufacturer's site) is reached, the setpoint is again modified so that the refrigerant moves away from the unstable region/wet region and closer to the stable region/dry region (again until a certain value that may be set by the user or at the manufacturer's site is reached). Further, based on the observation that the size and/or speed of the fluctuations, in particular the variance of the fluctuations, is a more or less directly correlating parameter of the amount of residual liquid and/or the level of superheat, the size and/or speed of the fluctuations can be used to control the refrigeration cycle in a way that a certain desired setpoint of the size and/or the speed of the fluctuations is reached. As an example, if the measured and calculated variance of the measured capacitance is higher than the defined setpoint, the opening degree of the pressure drop inducing device may be reduced and/or the evaporator's fan may be actuated to rotate faster, which results in an increased superheat of the refrigerant at the exit of the evaporator, which in turn results in a lowering of the variance of the measured capacitance.

First experiments have also shown that this location between the evaporator and the compressor (which is highly preferred for measuring a liquid droplet content in the gaseous phase of the refrigerant) is also particularly advantageous for measuring the water content of the fluid. All of this is of course advantageous.

When the (or an additional) apparatus is placed between the compressor and the condenser, a gas to liquid ratio within the liquid may be particularly advantageously measured, more particularly the content of liquid droplets in a gaseous phase of the fluid can be advantageously measured. This is particularly advantageous if certain types of compressors are used that may pump gaseous fluid that contains a certain fraction of liquid droplets. Turbo-compressors, more particularly so-called Danfoss Turbocor® compressors, are an example for such compressors. A measurement of the gas to liquid ratio at this position may be used for controlling the refrigeration cycle in a way that it is operating particularly efficient. Indeed, it is to be noted that it may be even advantageous if a certain amount of liquid droplets enters such a turbocompressor (or other designs with the fluid receiving capability), and potentially even leave such a compressor. This is because the liquid droplets may perform an internal cooling of the compressor.

Further, a method for measuring the water content of a fluid, in particular of a refrigerant, is suggested, the method using the capacitance measurement of at least one capacitive sensing element that comprises at least two electrodes, where the fluid to be measured passes through the capacitive sensing element between the at least two electrodes of the capacitive sensing element, and calculating an output signal being indicative of the water content in the fluid based on the measured capacitance of the at least one capacitive sensing element, wherein the at least one capacitive sensing element is designed and arranged as a direct current-decoupled device. When employing this method, the same features and characteristics, as already described in connection with the presently disclosed apparatus and/or refrigeration cycle may be realised as well, at least in analogy. Furthermore, the presently proposed method can be modified in the sense of the present disclosure as well, at least in analogy. This may result in the same or in at least similar features, characteristics and advantages as already described, at least in analogy.

In particular it is possible to modify the method in a way that said at least two electrodes consist of (essentially) the same material and/or are electrically isolated from the fluid. Again, the already described characteristics, features and advantages can be realised by employing the thus modified method, at least in analogy.

Furthermore, it is possible to modify the method in a way that the control logic outputs a water content signal, in particular a PPM value, preferably using prior calibration data. Again, this may result in the already described characteristics, features and advantages, at least in analogy.

Even more, the method may be employed in a way that the method is used, using an apparatus according to the present disclosure and/or in a way that the method is employed for a refrigeration cycle according to the present disclosure. This may result in a particularly advantageous use of the method, resulting in a particularly advantageous and versatile refrigeration cycle and/or apparatus.

Further advantages, features, and objects of the invention will be apparent from the following detailed description of the invention in conjunction with the associated drawings, wherein the drawings show:

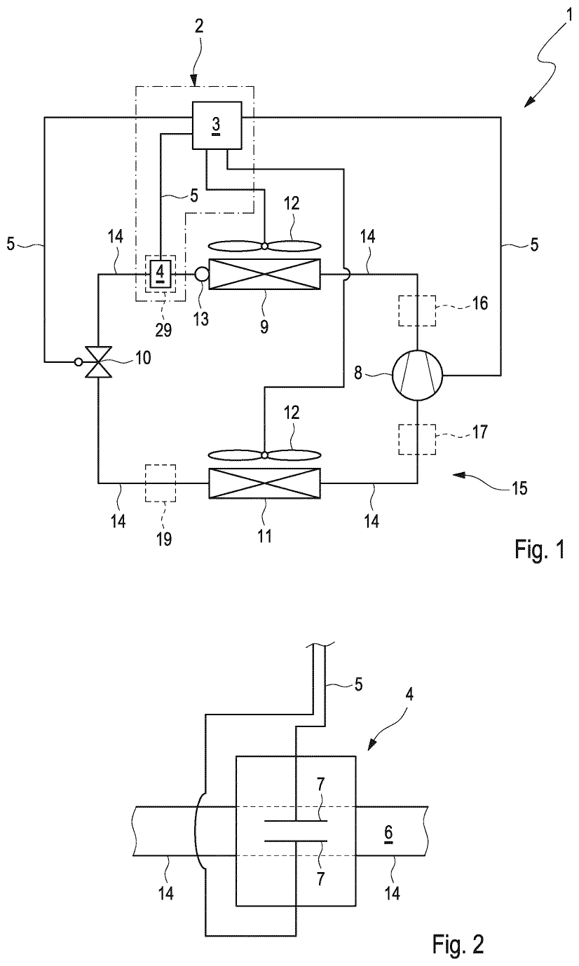

FIG. 1: A schematic circuitry of a refrigeration cycle with an apparatus comprising at least one capacitive sensing element according to the present disclosure;

FIG. 2: a schematic, enlarged view of a possible design of a capacitive sensing element of the refrigeration cycle according to FIG. 1;

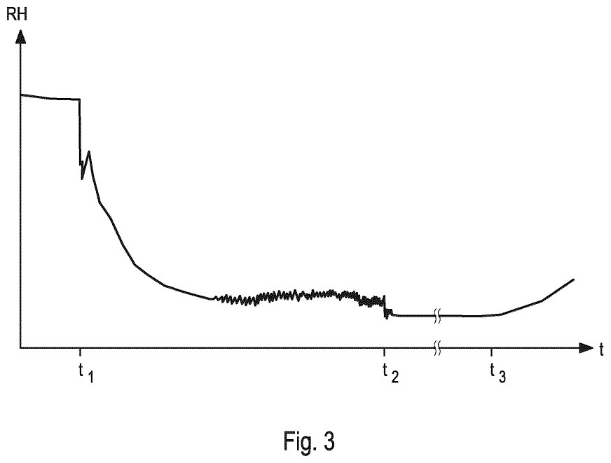

FIG. 3: a graph showing a humidity measurement of an operating refrigeration cycle according to FIG. 1, showing measurement values as measured by a capacitance sensor according to the present disclosure;

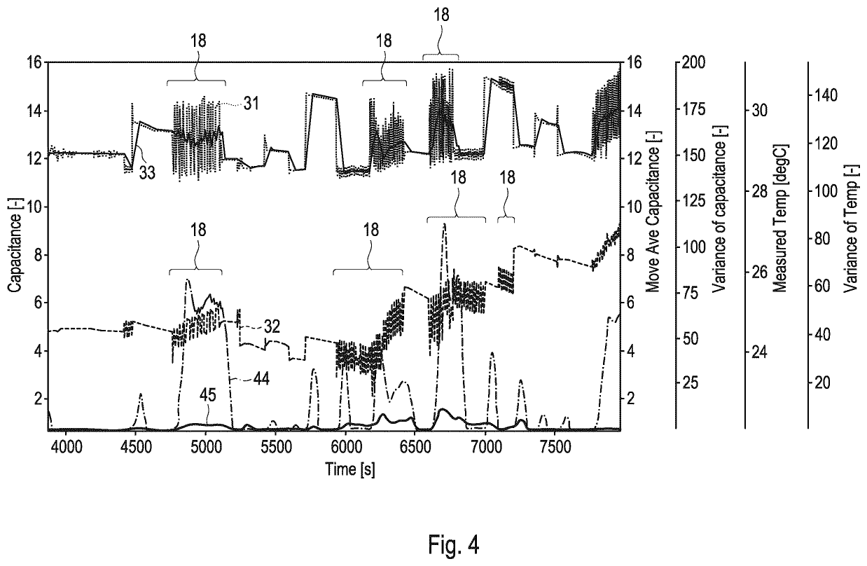

FIG. 4: a graph showing the bubble content in a refrigerant of a refrigeration cycle according to FIG. 1, as measured by a capacitance sensor as presently disclosed, and as measured by a temperature sensor;

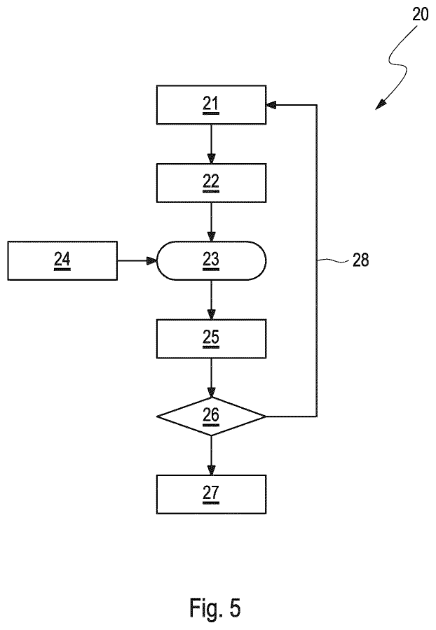

FIG. 5: a flow chart of a possible embodiment for measuring the water content in the refrigerant of a refrigeration cycle using an apparatus according to the present disclosure;

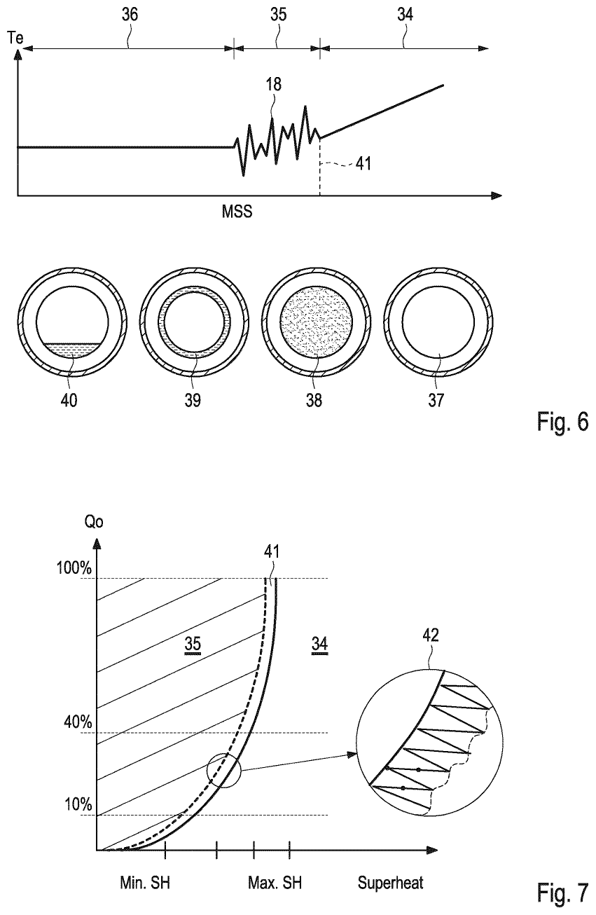

FIG. 6: a graph, showing the temperature of the refrigerant in dependence of the remaining liquid content in a largely gaseous phase of a refrigerant, together with optical pictures of the refrigerant in the conveying tube;

FIG. 7: a load versus superheat diagram of the refrigerant in the conditions similar to FIG. 6 for illustrating a minimum stable superheat control algorithm;

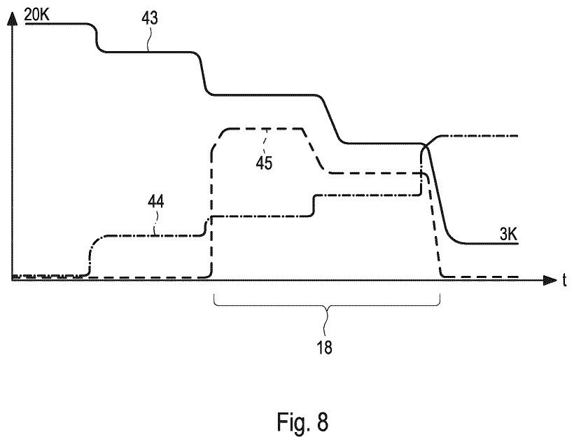

FIG. 8: a graph, showing the variance of a capacitance measurement and the variance of a temperature measurement downstream of an evaporator in dependence of the level of superheat of the refrigerant,

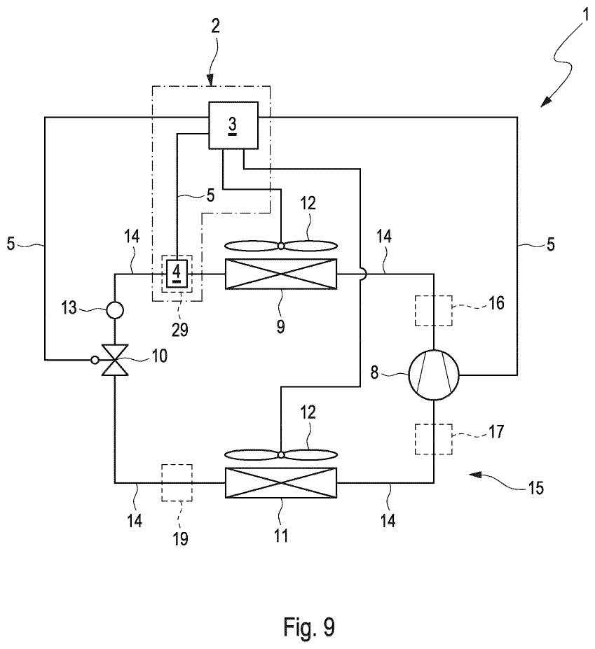

FIG. 9: a schematic circuitry of a refrigeration cycle similar to FIG. 1, with an apparatus comprising at least one capacitive sensing element according to the present disclosure, where the filter cartridge is placed at a different position.

FIG. 1 shows a schematic circuitry of a refrigeration cycle 1, comprising an apparatus 2 according to the present disclosure for measuring the water content in the refrigerant 6 that is contained and pumped around in the various tubes 14 and parts 8, 9, 10, 11, 13 of the closed circuit 15 of refrigeration cycle 1.

As usual, the refrigeration cycle 1 comprises a closed circuit 15 that is formed by a compressor 8, a condenser 9, a pressure drop inducing device that is presently designed as a throttle valve 10, and an evaporator 11 that are connected to each other using a plurality of tubes 14. Furthermore, in the presently shown embodiment the refrigeration cycle 1 comprises a filter cartridge 13 that is filled with a desiccant. Presently, the filter cartridge 13 is arranged at the fluid exit port of condenser 9. In particular, the filter cartridge 13 is arranged in a receiving space (tube-like structure) that is designed to be an integral part of the condenser 9. Certainly, the receiving space can be designed to be separate from the condenser 9 as well (like it is done in the embodiment according to FIG. 9).

Of course, it is possible to place the filter cartridge 13 at a different position within the refrigeration cycle 1. In particular, the filter cartridge 13 may be placed in the suction line of the compressor 8 (i.e. between evaporator 11 and compressor 8).

It is to be noted that it is possible that additional parts are arranged within the refrigeration cycle 1 as well. The aforementioned pumping of the refrigerant 6 within the closed circuit 15 of refrigeration cycle 1 is effectuated by the compressor 8.

The apparatus 2 comprises an electronic control logic 3 that presently comprises a programmable digital computer. Further, the apparatus 2 comprises a capacitive sensing element 4 that is connected to the electronic control logic 3 by means of an electric cable 5 to supply the capacitive sensing element 4 with an electric AC current, and further to be able to read out a measurement value to determine the water content within the refrigerant 6 (and furthermore additional measurement information, as will be explained later). Additionally, the gas bubble content in the mainly liquidous phase of the refrigerant 15 may be measured, when the capacitive sensing element 4 is placed at position 29 between the condenser 9 and the throttle valve 10 (as indicated in FIG. 1). Furthermore, not only the water content, but also the liquid droplet content in the mainly gaseous phase of the refrigerant 15 may be measured, when the capacitive sensing element 4 is placed at position 17 between the evaporator 11 and the compressor 8 (see alternative position 17 in FIG. 1).

The capacitive sensing element 4 is shown in more detail in the schematic view of FIG. 2. The capacitive sensing element 4 is designed and arranged in a way that fluid 6 (i.e. a refrigerant 6, for example R134a or R744) that circles within the various tubes 14 and parts 9, 10, 11, 13 of the closed circuit 15 of refrigeration cycle 1 passes through the body of the capacitive sensing element 4. Inside the capacitive sensing element 4, presently a pair of (i.e. two) plate-shaped electrodes 7 is arranged in a way that the plates of the plate-shaped electrodes 7 are essentially fully immersed in the refrigerant 6. The electrodes 7 are presently made of the same material, which is typically some kind of an electrically conductive metal or metal alloy. Possibly, the electrodes 7 might be covered with an electrically insulating coating. This, however, is not a must. The plate shaped electrodes 7 of the capacitive sensing element 4 are electrically connected to the electronic control logic 3 by means of an electric cable 5, as already indicated in FIG. 1.

Presently, the capacitive sensing element 4 is shown (in particular in FIG. 2) in a way that the space between the two plate-shaped electrodes 7 is empty/comprises a void/does not show an interspaced (non-water absorbing and/or solid-state) material. However, the presently presented disclosure applies to a capacitive sensing element 4 as well (at least essentially and/or in analogy) if a (possibly porous) non-water absorbing, solid state material is placed between the two plate-shaped electrodes 7 (so that the void between the electrodes 7 is at least partially filled by a solid-state material).

Furthermore, the already mentioned capacitive sensing element 4 is arranged within the closed circuit 15 of the refrigeration cycle 1. Presently, the capacitive sensing element 4 is arranged between the condenser 9 and the throttle valve 10, more particularly between the filter cartridge 13 and the throttle valve 10. In first experiments, this position has proven to be advantageous when it comes to measuring the water content within the refrigerant 6. Here, the measurement resolution seems to be the best. In particular, if the capacitive sensing element 4 is additionally used for measuring a gas to liquid ratio of the refrigerant 6, the presently chosen position of the capacitive sensing element 4 downstream of the filter cartridge 13 is particularly beneficial, since (apart from the measuring the water content) not only a too low subcooling of the refrigerant 6 can be detected, but also a clogging of the filter cartridge 13.

However, it is also possible to arrange the capacitive sensing element 4 in different positions 16, 17, 19, 29.

In particular, capacitive sensing element 4 may be arranged at position 17 within the closed circuit 15 of the refrigeration cycle 1. This position is the typical position of choice when it comes to measuring the (residual) liquid droplet content in the mainly gaseous phase of the refrigerant 6 (apart from the measurement of the water content). The knowledge thereof is highly advantageous to optimise the operation of refrigeration cycle 1 with respect to the performance of the evaporator 11. Furthermore, when using this position 17, a too high intake of liquid droplets into the compressor 8 can be avoided, which can be harmful to the compressor. At least such liquid drops can induce an unnecessarily high wear of the compressor 8. The tolerable amount of liquid droplets does depend on the design of the compressor 8.

In particular, if a so-called turbo-compressor is used as compressor 8, the tolerable amount of liquid droplets may be comparatively high. In particular, it may be so high that liquid droplets may even leave the compressor 8. To be able to measure the amount of liquid droplets that leave the compressor 8, capacitive sensing element 4 may be arranged at position 16 between the compressor 8 and the condenser 9. It is to be noted that when using a turbo-compressor as compressor 8 it may be even advantageous for the performance of the refrigeration cycle 1 if a certain amount of liquid droplets does leave the compressor 8. This is due to the fact that turbo-compressors (and potentially certain other designs as well) can advantageously use refrigerant for internal cooling purposes.

The position 19 between the throttle valve 10 and the evaporator 11 is normally not preferred, however. Furthermore, it should be noted that it is possible to use a plurality of capacitive sensing elements 4, in particular two or three capacitive sensing elements 4. Furthermore, the closed circuit 15 may comprise additional sensors like temperature sensors, pressure sensors and so on.

Presently, the electronic control logic 3 of the apparatus 2 for measuring the water content in the refrigeration cycle 1 is dimensioned in a way that it can perform additional control and surveillance functions. This is indicated by additional electric cables 5 that do connect to the compressor 8, as well as to the fans 12 of condenser 9 and evaporator 11. Furthermore, the pressure drop inducing device (presently in form of a throttle valve 10) is presently designed to be a controllable throttle valve 10, where the control of the throttle valve 10 can also be performed by the electronic control logic 3 of the apparatus 2 for measuring the water content in the refrigerant 6.

In FIG. 3, a schematic graph of a first measurement experiment using the presently proposed refrigeration cycle 1 with an apparatus 2 for measuring the water content, using a capacitive sensing element 4 is shown. The graph shows the relative humidity of the refrigerant 6 along the ordinate over time (plotted along the abscisa=time axis). This value is a function of the temperature, the density (pressure) and the water content (for example as measured in PPM) of the fluid 6. When the refrigeration cycle 1 is running, the temperature, as well as the density of the fluid 6 are essentially constant at various points within the closed circuit 15 of the refrigeration cycle 1. One of these points is the presently chosen position 29 of the capacitive sensing element 4 between the condenser 9 and the throttle valve 10. It is to be noted that usually the fluid 6 is essentially a liquid at this point when the refrigeration cycle 1 is running, where liquids are—as usual—considered to be a non-compressible. Furthermore, the liquid refrigerant is in a phase, in which the measured capacitance of the capacitive sensing element 4 will be clearly dependent on the water content within the refrigerant (highest capacitance interval; third capacitance interval as elucidated above and below). Therefore, the measurement value can be used to determine the water content of the fluid 6 in PPM (parts per million). As one can see, after the refrigeration cycle 1 has been filled with refrigerant 6, there is a certain water content present immediately after filling. At time t₁, the refrigeration cycle is switched on and the refrigerant 6 is pumped around the refrigeration cycle 1 using the compressor 8. Due to the pumping, the refrigerant 6 is forced through the various components 8, 9, 10, 11 and in particular through the filter cartridge 13 with a desiccant. Therefore, due to the absorption of water within the desiccant of filter cartridge 13, the water content initially drops after time t₁. At a certain time (indicated by t₂), the water content has reached its minimum value. The timescale between t₁ and t₂ is typically in the order of several hours.

After a certain time span of usually several weeks, months or even years, the desiccant in the filter cartridge 13 will become saturated. Therefore, it cannot absorb water anymore. This occurs at time t₃. It is to be noted that the timescale between t₂ and t₃ is interrupted in the graph of FIG. 3, as it is shown by a double slash on the abscissa.

Once the desiccant in the filter cartridge 13 is saturated, the water within the refrigerant 6 will increase in quantity. Therefore, the water content in the refrigeration cycle 1 will start to rise, as can be seen on the very right side of FIG. 3 (right of t₃).

Additionally, the apparatus 2 (that is presently placed at position 29) is used for measuring the bubble content of gaseous bubbles in the (mainly) liquidous phase of the refrigerant 6 in the tube 14 between the condenser 9 and the throttle valve 10. Two measured (main) parameters 31, 32, namely measured capacitance 31 and measured temperature 32, that were recorded using an experimental setup of the refrigeration cycle 1 are shown in FIG. 4. The respective values 31, 32 were measured with a sampling rate of one second (i.e. one measurement per second) over time (altogether approximately 4000 seconds, i.e. approximately one hour). Time is plotted along the abscissa (x-axis). Furthermore, additional parameters 33, 44, 45 that are calculated from the measured main parameters are shown in FIG. 4, namely moving average capacitance 33, variance of the measured capacitance 44 and variance of the measured temperature 45. It is to be noted that in the experimental setup a new—and hence unclogged—filter cartridge 13 has been used, so that the placement of the capacitive sensor element 4 upstream (see FIG. 9) or a downstream (see FIG. 1) of the filter cartridge 13 is essentially irrelevant with respect to the presented measurements.

After a run-up phase of the refrigeration cycle 1 (compressor 8 has started to pump), due to varying thermal load on the refrigeration cycle 1, it is typical that at some point very fast and random changes 18 in the measurement value of capacitance 31 (capacitance as measured by the capacitive sensor element 4 at position 19) occur, which can be clearly seen in FIG. 4. This is due to the occurrence of bubbles in the liquid, namely due to the fact that the bubbles will adhere to the plate-shaped electrodes 7 for a short time, before they are again conveyed along with the flowing refrigerant 6. The typical timescale for the fluctuations is 1 to 5 seconds.

While the explanation in the previous paragraph might not be (fully) applicable to a case in which a solid-state material is placed between the electrodes 7 of the capacitive sensor element 4, first experiments clearly indicate that the fast fluctuations can still be observed. Even more, surprisingly, the sampling rate/measuring speed of the standard type commercially available analog-digital converter that was used in the setup of those first experiments, seems to be the limiting factor (i.e. the fluctuations of the capacitance of the capacitive sensor element 4 are faster than the sampling rate of the analog-digital converter).

Furthermore, for comparison, the temperature 32 of the refrigerant 6, leaving the condenser 8 is shown. Even further, additional parameters that have been derived from the measured values of capacitance 31 and temperature 32 are shown in FIG. 4 for comparison, namely the smoothened measured capacitance 33 (time average over a window of a certain number of measurement points-presently n=25 measurement points—where the average is calculated in a window that moves along with time), the (smoothened) variance of the capacitance 44 and the (smoothened) variance of the temperature 45. The variances 44, 45 are calculated according to the usual definition, i.e. the variances are calculated using

$${\sum }_{i = 1}^{n} \frac{{( {x}_{i} - \overline{x} )}^{2}}{n} .$$

For a good smoothing of the variances 44, 45, n is chosen to be comparatively high (where n is the number of measurement points of the respective measured value with a measurement rate of one measurement per second). Presently, it is chosen to be n=25.

Again, this not only applies to the case were the space between the electrodes 7 is (essentially) empty, but surprisingly also to the case where a non-water absorbing solid-state material is placed between the electrodes 7.

The data shown in FIG. 4 clearly shows that the measured capacitance 31, and in particular the calculated variance of the capacitance 44, do constitute a good indication for the presence of bubbles within the mainly liquidous refrigerant 6 that is leaving the condenser 9. In particular, it can be seen that the capacitance 31 (and the variation 44 thereof) yields a more distinct signal as compared to the temperature 32 (and the variation 45 thereof).

This, in turn, indicates that a better control of the refrigeration cycle 1 is possible, when using a capacitance value (either measured capacitance 31 or more particularly the variance of the capacitance 44) instead of the formerly used temperature value.

Only for completeness it should be noted that the control aim should be to have no bubbles at the entrance port of the throttle valve 10. From a theoretical point it is best that the subcooling is essentially 0 K (being essentially equivalent to the statement that the “no bubble”-threshold is reached only at the very last centimeter of the condenser 8). However, in practice, usually a certain safety margin is used, allowing a certain subcooling (typically in the range of 2 K to 3 K).

In particular in this context it should be noted that when placing the capacitive sensing element 4 between the condenser 9 and the filter cartridge 13 (the filter cartridge 13 being placed upstream of the throttle valve 10; embodiment according to FIG. 9), the measured ratio value of gas versus liquid of the refrigerant 15 is not influenced by any evaporation of the refrigerant 6 due to a blockage effect of the filter cartridge 13. It is therefore very suitable for measuring the residual gas/subcooling of the refrigerant 15 at the exit port of the condenser 9, in an effort to optimise the efficiency of the condenser 9. It is to be noted that in particular after a certain time the filter cartridge 13 may become partially blocked, thus resulting in a certain throttling behaviour of the filter cartridge 13, potentially generating a certain gas content in the refrigerant 15 downstream of the filter cartridge 13 (although the refrigerant 6 might be completely in the liquidous phase—and possibly even subcooled to a certain extent—at the exit port of condenser 9). Thus, the filter cartridge 13 acts as a so to speak “partial throttle valve”. This may be problematic since the “real” throttle valve 10 typically expects liquid only at its entrance port, which may result in bad controllability of the refrigeration cycle 1. The downside of the arrangement according to FIG. 1 is that usually a separate housing for the filter cartridge 13 is needed, usually resulting in somewhat increased cost and usually in additional mounting space requirements.

However, it is also possible to arrange the capacitive sensing element 4 between the filter cartridge 13 and the throttle valve 10, as it is shown in FIG. 1. This arrangement may prove to be advantageous, since it is easier to control the refrigeration cycle 1 in a way that the throttle valve 10 receives “liquid only” at its entrance port. Another advantage of this arrangement is that the capacitive sensing element 4 may be used to measure a (partial) blockage of the filter cartridge 13. This information may be used to generate an output signal, indicating that maintenance is needed. Even further, an integral design of the receiving space for the filter cartridge 13 together with the condenser 9 may be realised (quite often a part of a collecting tube-even including an extension thereof—of the condenser 9 is used as a receiving space for the filter cartridge).

It is to be noted that when the apparatus 2 is arranged at a position 17 between the evaporator 11 and the compressor 8 or at position 16 between the compressor 8 and the condenser 9, thus measuring the amount of liquid droplets in an essentially gaseous phase of the refrigerant 6, fast erratic spikes 18 can be seen as well. Here, liquid droplets will adhere to the plate-shaped electrodes 7 for a short time, before they are again conveyed along with the flowing refrigerant 6. This is similar to the situation of gas bubbles interacting with the electrodes 7 of the capacitive sensor element 4 being placed at position 29 between condenser 9 and throttle valve 10.

The physical relevance of a measurement of the ratio value of gas to liquid in the refrigerant 6, in particular of residual liquid droplets in the essentially gaseous phase of refrigerant 6 at position 17 between the evaporator 11 and the compressor 8 can be seen in FIG. 6. The abscissa shows the ratio of gas versus liquid in the refrigerant 6, where the right side of FIG. 6 is equivalent to a high gas content. The ordinate shows the temperature of the refrigerant which is equivalent to the temperature curve 32 in FIG. 4. If the gas content is essentially 100% (stable dry region 34 in FIG. 6), the temperature of the refrigerant 6 on the downstream side of evaporator 11 is “higher than necessary”, i.e. a superheating of the refrigerant 6 is present (which can be seen by the rising graph). That a single gas flow is present can be seen from the lower line of FIG. 6. Here optical pictures of the fluid through a window is shown. Namely, in the stable dry region 34 a single gas flow 37 is visible.

On the other hand, if a relevant amount of liquid is still present, we are in the constant temperature region 36 where input or removal of thermal energy will result in a decreasing or increasing ratio of liquid (with constant temperature). This can be seen in FIG. 6, lower line of pictures, where a segregated flow 40 (bottom part liquid; upper part gas) is present for the high liquid content area. If the amount of liquid decreases, this situation is followed by an annular flow 39 (outer rim: liquid; inner core: gas), before the unstable zone 35 with random changes of temperature 18 is reached. In the random zone 35 with random changes of temperature 18, a mist flow 38 is present, i.e liquid droplets are conveyed along with the mainly gaseous phase of refrigerant 6.

The optimum point for operating the refrigeration cycle 1 is the changeover point 41 between the unstable zone 35 and the increasing temperature zone 34. It is to be noted that measurements surprisingly indicate that even in the superheated region with a low level of superheat, a certain amount of droplets is still contained in the gaseous fluid flow. Therefore, the mist flow 38 can be observed in this low-superheated region as well. There is support that this low-superheated region extends to some 25 K to 30 K above the changeover point 41. It is to be noted that typically above some 10 K of superheat, the droplets are not visible anymore with the bare eye, although those droplets still cause variations in the measured capacitance.

This behaviour gives rise to a possible control method, called the minimum stable superheat (MSS) control method, that will be explained in more detail below.

It further gives rise to another possible control method (or a combination of both methods), where the variance of the fluctuating signal in the random changes region 18 is used as a measure for determining the level of superheat of the refrigerant 6. This method will also be described in more detail below.

It is of course obvious that the timescale for the ratio value of gas versus liquid and/or the occurrence of bubbles/droplets and the timescale with respect to water content are clearly separated from each other by even several orders of magnitude in time. Therefore, it is easily possible to program the apparatus 2 for performing the measurements in a way that clearly distinct measurement values for the various physical parameters are generated.

Furthermore, first experiments showed that at least for certain setups the measured capacitance ranges are distinct for certain conditions of the refrigerant. Namely, three distinct ranges could be observed: in the lowest capacitance interval, the refrigerant is in a (fully) gaseous state. In a medium capacitance interval, a mixture of gaseus and liquidous refrigerant is present between the at least two electrodes 7 of the capacitive sensing element 4. In the highest capacitance interval, the refrigerant is in a (essentially) fully liquidous state, and the measured capacitance increases with increasing water content of the (fully liquidous) refrigerant. Thus, measuring of the water content of the refrigerant might be limited to cases, where the capacitive sensing element 4 is arranged at an appropriate place within the refrigeration cycle 1 (so that an essentially fully liquidous state of the refrigerant can occur at least at times under realistic operational conditions of the refrigeration cycle 1). Additionally or alternatively, the measurement of the water content of the refrigerant may only be made when the refrigeration cycle 1 is operated in an operational condition, in which one can be at least reasonably certain that the refrigerant in the capacitive sensing element 4 is essentially fully liquid.

In FIG. 5, a possible flowchart 20 for performing a measurement of the water content within the closed circuit 15 of refrigeration cycle 1 is shown.

First, an AC signal is applied (step 21) to the electrodes 7 of the capacitive sensing element 4. Based on the signal response, a measurement value of capacitance is obtained (step 22). This capacitance value as determined in step 22 is compared (step 23) with the data that is stored in a previously created lookup table (step 24). By this comparison (step 23) a water content is obtained (preferably in PPM=parts per million). The thus determined (step 25) water content is compared with a threshold value in step 26. If the threshold value is exceeded, as a next step, a warning signal is issued (step 27). If, however, in step 26 it is determined that the threshold value is not yet reached, the method will be repeated from the beginning (step 28).

Advantageously, this measurement of the water content is only performed when the refrigeration cycle 1 has been operated for a certain time and is/has been operated under operating conditions so that it is reasonably certain that the refrigerant is essentially in a liquidous state in the capacitive sensing element 4. This way, the capacitive range will be within the third capacitance interval/highest capacitance interval. This will ensure reliable water content data.

A similar method may be used for performing a measurement of the ratio value of gas to liquid of a fluid within the closed circuit 15 of refrigeration cycle 1.

Such an appropriately adapted method may be used to operate the refrigeration cycle 1 according to the so-called minimum stable superheat control algorithm:

Firstly, the refrigeration cycle 1 is controlled in a way (for example by the electronic control logic 3) that it operates in the stable, dry increasing temperature region 34 (see FIGS. 6 and 7). Then, to optimise the performance of the evaporator 11 without exposing the compressor 8 to excessive wear, the algorithm drives the refrigeration cycle 1 slowly towards the unstable zone 35 (constant temperature zone 36). This is usually done by varying the opening degree of the throttle valve 10, presently by increasing the opening degree of the throttle valve 10. This has, in turn, an effect on the pressure in the tube 14 between condenser 9 and throttle valve 10, and consequently between compressor 8 and condenser 9 (presently a reduction of the pressure), thus resulting in a variation of the fluid flow that is pumped by the compressor 8 (presently an increase in the fluid flow throughput rate through compressor 8).

As already mentioned, in particular in more sophisticated systems, additional control methods may be used, like control of condenser fan 12 speed, control of evaporator fan 12 speed and/or control of the pumping rate of the compressor 8. Control of the condenser fan 12 speed and/or of the evaporator fan 12 speed may encompass a toggling between a switched-on (100%) and a switched-off (0%) position, a toggling between a switched-on (100%), a partially switched-on (for example 50%; possibly even more intermediary positions) and a switched-off (0%) position, and/or a continuous variability of the speed of the respective fan 12. Furthermore, to reduce fluctuations on both the evaporator side and the condenser side, it is possible to use systems which employ a certain mass buffer for the refrigerant 15, in particular by using a fluid accumulator. Such a fluid accumulator may be arranged neighbouring the condenser 12 and/or evaporator 11 (typically on the respective downstream side, but possibly on the upstream side as well).

If the capacitive sensing element 4 starts to detect random changes 18, this is an indication that we are very close or even slightly past the optimum change over point 41. Therefore, the operation of the refrigeration cycle 1 is “reversed” in the sense that it is operated in a way that refrigerant 6 is slowly moved towards the stable dry region/increasing temperature region 34. This can be done by decreasing the opening degree of the throttle valve 10, which will result in a decreased pumping rate of the compressor 8, as explained above.

This, however, is only done for a short time and the operation is altered in a way to move closer to the unstable zone 35 again. This back-and-forth operation can be particularly seen in enlarged view 42 of FIG. 7.

Another possible control strategy (where this control strategy can preferably be combined with the MSS control strategy as previously described) can be realised by using the observations according to FIG. 8. Along the abscissa (x-axis) the advancing time during an experiment is shown. During this experiment, the level of superheat of the refrigerant 6, exiting evaporator 11 is decreased in several steps. The temperature curve 43 shown starts at 20 K superheat on the left side of the graph of FIG. 8, and goes downward to 3 K superheat on the right side of the graph of FIG. 8. This is also indicated by an appropriate labelling along the abscissa.

Furthermore, the variance curve of the capacitance 44 is shown in the graph of FIG. 8. The variance is calculated according to the usual definition, i.e. the variance is calculated using

$${\sum }_{i = 1}^{n} \frac{{( {x}_{i} - \overline{x} )}^{2}}{n} .$$

For a good smoothing of the variance of the capacitance curve 44, n is chosen to be comparatively high (where n is the number of measurement points of the measured capacitance with a measurement rate of one measurement per second). Presently, it is chosen to be n=25. As can be seen, for the window of superheat chosen (i.e. between 20 K and 3 K of superheat of refrigerant 6), there is a very strong and strictly monotonic correlation between the variance and the degree of superheat of the refrigerant 6.

For comparison, the variance of the measured temperature 45 (using an additional temperature sensor at position 17 between evaporator 11 and compressor 8 that is not shown in FIG. 1) is shown in FIG. 8 as well. It can be seen that a significant (non-zero) value of the variance of the temperature 45 occurs only at the unstable zone 18 that is visible in FIG. 6 (which is of course reasonable). Therefore, from the variance of the temperature 45 alone it cannot be concluded, on which side of the unstable zone 18 the refrigeration cycle 1 is currently operated. Contrary to this, the temperature range of usability is significantly higher for the variance of the measured capacitance 44. Namely, from the variance of the measured capacitance 44, one can conclude on which side of the unstable zone 18 the refrigeration cycle 1 is currently operating. Consequently, an appropriate modification of the actuation scheme refrigeration cycle 1 can be made to move the operation of the refrigeration cycle 1 towards the desired optimum (as previously mentioned, this can be realised by appropriately setting the opening degree of the throttle valve 10, just to name an example).

Again, it should be noted that in the low-superheat region (i.e. already with the presence of perhaps 0 K to 25 K superheat of the refrigerant 6), a certain amount of liquid droplets within the generally gaseous phase of the refrigerant 6 downstream of the evaporator 11 is surprisingly present. This is something that is possibly hard to detect with the bare eye through a glass window, however.

Further information can be found in the patent application that is filed for the same applicant under the applicant's reference numerals DAN2207cDKWO/PA17957WO01 on the same day.

It is to be noted that a single one or a plurality of the features of the presently disclosed detailed embodiments may be used in combination with the generic description of the present disclosure. This also applies to the generic description and/or the embodiments of the previously mentioned referenced applications.

1. Apparatus (2) for measuring the water content of a fluid (6), in particular of a refrigerant (6), comprising at least one control logic (3) and at least one capacitive sensing element (4) comprising at least two electrodes (7), wherein the apparatus (2) is designed and arranged in a way that the fluid (6) is present between said two electrodes (7), wherein the control logic (3) measures the capacitance of the capacitive sensing element (4) and derives a measurement signal to be outputted that is indicative of the water content, characterised in that the capacitive sensor element (4) is designed and arranged as a direct current-decoupled device.

2. Apparatus (2) according to claim 1, characterised in that said at least two electrodes (7) consist of the same material and/or are electrically isolated from the fluid (6) to be measured.

3. Apparatus (2) according to claim 1 or 2, characterised in that said at least two electrodes (7) are designed and arranged in a way to be in contact with the fluid (6), preferably in a way to be essentially immersed in the fluid (6) to be measured.

4. Apparatus (2) according to any of the preceding claims, characterised in that it is designed and arranged in a way to measure the water content of a fluid (6) with a dielectric constant of less than 70, preferably of less than 60, even more preferred of less than 50.

5. Apparatus (2) according to any of the preceding claims, characterised in that the control logic (3) generates a water content signal, in particular a PPM value, preferably using prior calibration data.

6. Apparatus (2) according to any of the preceding claims, characterised in that the control logic (3) outputs a warning signal in case a certain water content level is exceeded and/or outputs an estimated remaining time until a certain water content level is prone to be reached or exceeded.

7. Apparatus (2) according to any of the preceding claims, characterised in that the control logic (3) also calculates a ratio value of gas versus liquid in a gas-liquid mixture fluid (6) and/or a value of bubble content in the fluid and/or a value of bubble content in the fluid (6) and/or a value of droplet content in the fluid (6), based on the capacitance of the capacitive sensor element (4).

8. Refrigeration cycle (1) comprising a compressor (8), a condenser (9), a pressure drop inducing device (10) and an evaporator (11), further comprising an apparatus (2) according to any of the preceding claims.

9. Refrigeration cycle (1) according to claim 8, characterised in that said at least one capacitive sensing element (4) is arranged between the condenser (9) and the pressure drop inducing device (10) and/or between the evaporator (11) and the compressor (8) and/or between the compressor (8) and the condenser (9).

10. Method (20) for measuring the water content of a fluid (6), in particular of a refrigerant (6), using the capacitance measurement of at least one capacitive sensing element (4) that comprises at least two electrodes (7), where the fluid (6) to be measured passes through the at least one capacitive sensing element (4) between the at least two electrodes (7) of the capacitive sensing element (4), and calculating an output signal being indicative of the water content in the fluid (6) based on the measured capacitance of the at least one capacitive sensing element (4), characterised in that the at least one capacitive sensing element (4) is designed and arranged as a direct current-decoupled device.

11. Method (20) according to claim 10, characterised in that said at least two electrodes (7) consist of the same material and/or are electrically isolated from the fluid (6).

12. Method (20) according to claim 10 or 11, characterised in that the control logic (3) outputs a water content signal, in particular a PPM value, preferably using prior calibration data

13. Method (20) according to any of claims 10 to 12, characterised in that an apparatus (2) according to any of claims 1 to 7 used and/or in that the method (20) is employed for a refrigeration cycle (1) according to any of claim 8 or 9.
